(19) United States
(12) Patent Application Publication
(10) Pub. No.: US 2025/0348983 A1
(43) Pub. Date: Nov. 13, 2025

(54) IMAGE PROCESSING APPARATUS, IMAGE PROCESSING METHOD, AND STORAGE MEDIUM

(71) Applicant: CANON KABUSHIKI KAISHA, Tokyo (JP)

(72) Inventors: TATSUYA TSUJI, Kanagawa (JP); TAISUKE NISHIO, Kanagawa (JP); NATSUKO SATO, Kanagawa (JP); MASASHI YAMAMOTO, Kanagawa (JP)

(21) Appl. No.: 19/197,722

(22) Filed: May 2, 2025

(30) Foreign Application Priority Data
May 7, 2024 (JP) 2024-075196

(51) Int. Cl. G06T 5/90; G01S 17/08; G06T 7/11; G06T 7/50

(52) U.S. Cl. CPC G06T 5/90; G01S 17/08; G06T 7/11; G06T 7/50

(57) ABSTRACT

An image processing apparatus includes at least one memory storing instructions and at least one processor, wherein execution of the stored instructions causes the at least one processor and the at least one memory to segment an input image into a plurality of regions, obtain subject distance information about a subject distance for each of the plurality of regions, perform a correction process for correcting fluctuation in the input image caused by atmospheric refraction of light, on each of the plurality of regions, and determine a correction intensity of the correction process for each of the plurality of regions based on the subject distance information about a corresponding region of the plurality of regions, wherein the determined correction intensities are different in at least two regions where the subject distance information differs between the at least two regions, among the plurality of regions.

### BACKGROUND

### Field of the Disclosure

The present disclosure relates to an image processing apparatus, an image processing method, and a storage medium.

### Description of the Related Art

In use cases of surveillance cameras, such as port monitoring and infrastructure monitoring, it is known that in performing telephoto imaging of ships or aircraft, fluctuations in the appearance of the subject caused by uneven changes in the atmospheric refractive index (such as mirages) can reduce the visibility of the subject.

Typically, when a captured image of a subject exhibits fluctuations, the resulting changes in pixel values are approximated by a normal distribution centered at a predetermined position. Thus, a known method for reducing fluctuations is smoothing the image in the temporal direction. However, with this temporal image-smoothing method, if the smoothing duration is extended, images of moving subjects may become blurred (hereinafter, referred to as motion blur).

Additionally, since fluctuations vary depending on factors such as the environment and time, if temporal smoothing is used to reduce the degree of fluctuation, the intensity of the temporal smoothing process is to be adjusted according to the degree of fluctuation.

To address this, International Publication No. 2015/040731 discusses a technique in which the pixels at the same position in an input image and a correction image are grouped based on their luminance, and temporal smoothing is applied to each group. According to the technique discussed in International Publication No. 2015/040731, fluctuation can appropriately be corrected according to the degree of fluctuation while preventing or reducing the adverse effects of temporal smoothing.

### SUMMARY

One issue to be solved by the present disclosure is to provide a technique for correcting fluctuations with a correction intensity that reflects the effect of fluctuations in each region.

According to an aspect of the present disclosure, an image processing apparatus includes at least one memory storing instructions and at least one processor, wherein execution of the stored instructions causes the at least one processor and the at least one memory to segment an input image into a plurality of regions, obtain subject distance information about a subject distance for each of the plurality of regions, perform a correction process for correcting fluctuation in the input image caused by atmospheric refraction of light, on each of the plurality of regions, and determine a correction intensity of the correction process for each of the plurality of regions based on the subject distance information about a corresponding region of the plurality of regions, wherein the determined correction intensities are different in at least two regions where the subject distance information differs between the at least two regions, among the plurality of regions.

Further features of various embodiments of the present disclosure will become apparent from the following description of exemplary embodiments with reference to the attached drawings.

### BRIEF DESCRIPTION OF THE DRAWINGS

FIG. 1 is a block diagram illustrating an apparatus configuration of an image processing apparatus.

FIG. 2 is a block diagram illustrating a functional configuration of an image processing apparatus.

FIGS. 3A, 3B, and 3C are diagrams illustrating the effect of fluctuation in an input image.

FIGS. 4A, 4B, and 4C are diagrams illustrating examples of fluctuation amounts.

FIGS. 5A, 5B, and 5C are diagrams illustrating examples of fluctuation corrections.

FIG. 6 is a diagram illustrating a relationship between correction intensity and motion blur.

FIG. 7 is a flowchart illustrating an example of a correction intensity determination process.

FIGS. 8A, 8B, 8C, and 8D are diagrams illustrating region segmentation.

FIG. 9 is a flowchart illustrating an example of a correction intensity determination process.

FIG. 10 is a diagram illustrating fluctuation information about individual regions.

FIG. 11 is a flowchart illustrating an example of a correction intensity determination process.

FIG. 12 is a diagram illustrating moving subject information about individual regions.

### DESCRIPTION OF THE EMBODIMENTS

Exemplary embodiments will now be described in detail with reference to the accompanying drawings. The following exemplary embodiments are not intended to limit every embodiment according to the claims. Although a plurality of features is described in the exemplary embodiments, not all of the plurality of features are necessarily essential to every embodiment, and the plurality of features may be combined as desired. In the accompanying drawings, the same or similar elements are denoted by the same reference numerals, and redundant description will be omitted.

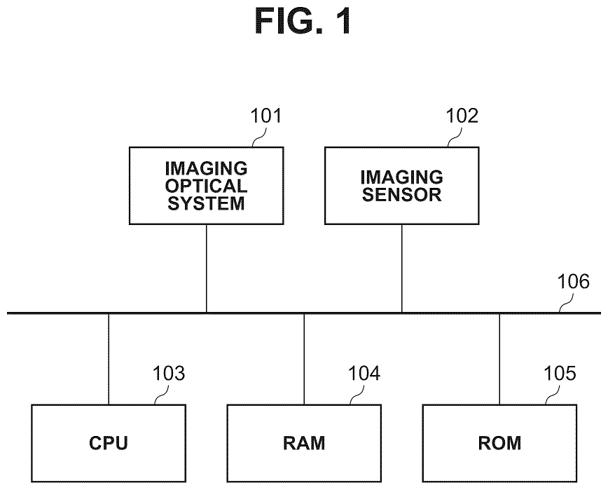

A first exemplary embodiment of the present disclosure will be described. Initially, an example of a hardware configuration of an image processing apparatus according to the present exemplary embodiment will be described with reference to the block diagram of FIG. 1. FIG. 1 illustrates main components relating to the following descriptions, and FIG. 1 does not necessarily illustrate all the components of the image processing apparatus. The hardware configuration illustrated in FIG. 1 is merely an example of a hardware configuration applicable to the image processing apparatus according to the present exemplary embodiment, and the hardware configuration can be modified or changed as appropriate.

### Apparatus Configuration

The image processing apparatus according to the present exemplary embodiment includes an imaging optical system 101, an imaging sensor 102, a central processing unit (CPU) 103, a random access memory (RAM) 104, and read-only memory (ROM) 105. Each component is electrically connected via a bus 106. Light incident on the imaging optical system 101 forms an image of a subject, and the formed image is captured by the imaging sensor 102.

The imaging optical system 101 includes a lens unit including one or more lenses. Examples of the lenses include a zoom lens that allows the adjustment of the focal length by being moved in the optical axis direction. The imaging optical system 101 includes other lenses, such as a focus lens configured to be moved in the optical axis direction to adjust the focus, and a teleconverter (extender) that can change optical characteristics. In the present exemplary embodiment, the configuration in which the image processing apparatus and the imaging optical system 101 are integrated is described as an example, but some embodiments are not limited to this. For example, the imaging optical system 101 may be disposed on a component external to the image processing apparatus, such as an interchangeable lens, and in that case, it is sufficient for the imaging optical system 101 to be connected to the image processing apparatus and able to communicate with the image processing apparatus.

The imaging sensor 102, which includes a plurality of photoelectric conversion elements, captures an image of a subject formed by the imaging optical system 101, and is a photoelectric conversion element including a plurality of pixels that generate image signals or image data. The image data and the image signals include information about a plurality of colors. These colors include, for example, red, green, and blue. The image data is obtained by converting light that has passed through color filters into electrical signals for red, green, and blue and then processing these signals. The color filters are disposed in front of the imaging sensor 102, and each corresponds to a corresponding color of the plurality of colors. The color filters transmit not only the visible light components corresponding to red, green, and blue but also some infrared light components from the non-visible light spectrum. The imaging sensor 102 may be a complementary metal oxide semiconductor (CMOS) sensor, a charge-coupled device (CCD) sensor, a single photon avalanche diode (SPAD) sensor, or the like. The imaging optical system 101 and the imaging sensor 102 may be disposed externally to the image processing apparatus as an imaging unit configured to obtain input images for the image processing apparatus. In such cases, the imaging unit outputs images to the image processing apparatus.

The CPU 103 is used for controlling the image processing apparatus in an integrated manner. The CPU 103 executes various processes using computer programs and data loaded into the RAM 104. Thus, the CPU 103 not only controls the operation of the entire image processing apparatus but also executes or controls the various processes described as the processes to be performed by the image processing apparatus.

The RAM 104 is a non-volatile memory, and the RAM 104 provides a working area to be used by the CPU 103 during execution of processing. Computer programs and data loaded from the ROM 105 are stored in the RAM 104. The RAM 104 functions as a frame memory or a buffer memory. The ROM 105 stores computer programs and data for causing the CPU 103 to execute or control various processes that are described as the processes to be performed by the image processing apparatus.

The image processing apparatus may include another processor, such as a graphics processing unit (GPU), and an image processing circuit. In which case, various processes described as the processes performed by the CPU 103 may partially or entirely be executed by the other processor or the image processing circuit.

### Functional Configuration

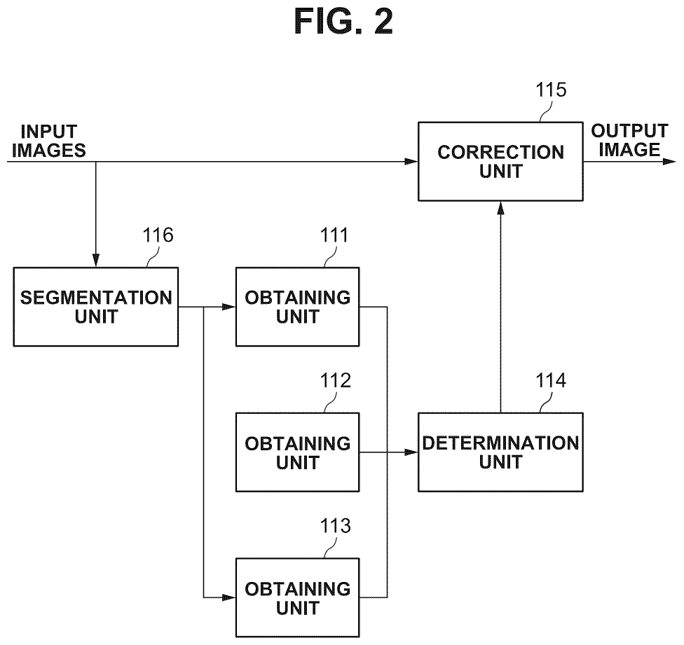

A functional configuration example relating to a process for correcting a fluctuation in an input image in the image processing apparatus according to the present exemplary embodiment will now be described with reference to the block diagram of FIG. 2. In the present exemplary embodiment, a case where the functional units illustrated in FIG. 2 are implemented in software (computer programs) will be described. In the following, the functional units in FIG. 2 may be described as the units that perform processing. However, in practice, the function of each functional unit is realized by the CPU 103 executing the computer program(s) corresponding to a corresponding functional unit of the functional units. One or more of the functional units illustrated in FIG. 2 may also be implemented in hardware.

The imaging sensor 102 outputs a RAW image of each frame. In a case where a moving image is captured using the imaging sensor 102, the RAW image of each frame corresponds to the image of the corresponding frame in the moving image. In a case where still images are captured periodically or intermittently using the imaging sensor 102, the RAW image for each frame corresponds to a corresponding still image of the still images.

An obtaining unit 111 obtains captured images generated by the CPU 103 as input images.

The obtaining unit 111 then obtains a fluctuation amount corresponding to each pixel of the obtained input images as fluctuation information.

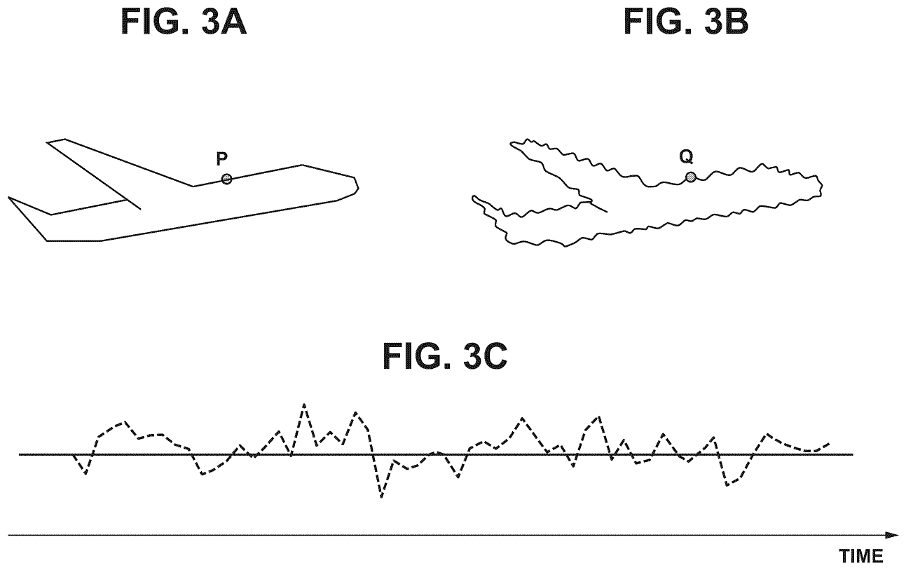

Here, the effect of fluctuation on input images will be described with reference to FIGS. 3A, 3B, and 3C. FIG. 3A illustrates an example of a captured image without fluctuation (hereinafter, referred to as a non-fluctuation captured image), obtained by capturing an image of a stationary subject in the absence of fluctuation. FIG. 3B illustrates an example of a captured image with fluctuation (hereinafter, referred to as a fluctuation captured image), obtained by capturing an image of a stationary subject in the presence of fluctuation.

As illustrated in FIGS. 3A and 3B, even in capturing an image of a stationary subject, phenomena, such as the occurrence of distortion in captured images, occurs in imaging in the presence of fluctuations. In FIG. 3C, the solid line represents the pixel values at a pixel position P in the non-fluctuation captured image of each frame, the dashed line represents the pixel values at a pixel position P in the fluctuation captured image of each frame.

In FIG. 3C, the horizontal axis represents time (frames) and the vertical axis represents the pixel values.

As illustrated in FIG. 3C, the pixel value at the pixel position P in the non-fluctuation captured image of each frame is almost constant, and the pixel value of the pixel position P in the fluctuation captured image of each frame varies. Thus, the presence of fluctuations induces a phenomenon where a stationary subject is imaged as if it were a moving subject.

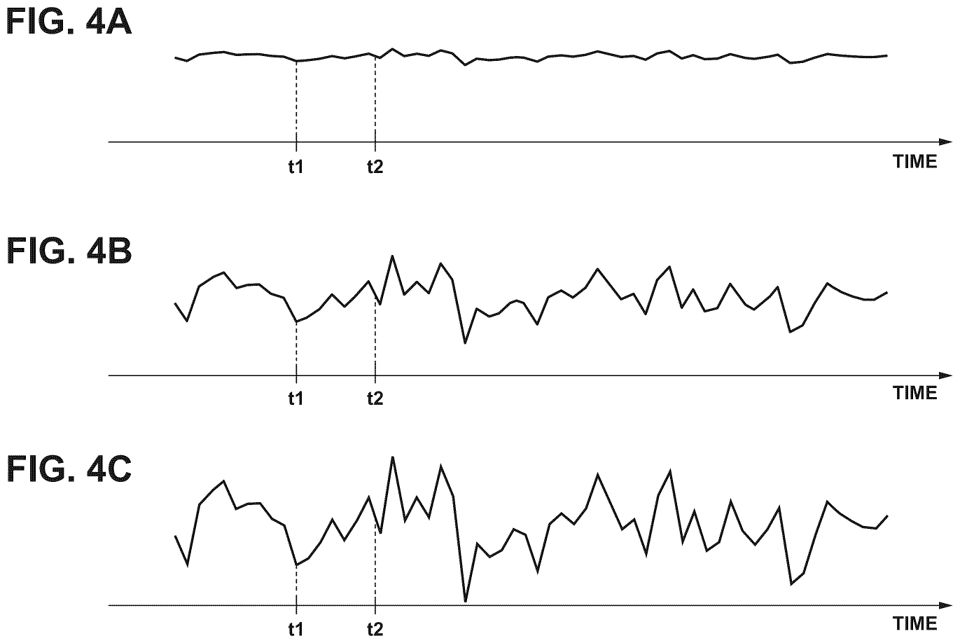

A method with which the obtaining unit 111 obtains fluctuation information for each pixel position in an input image will be described with reference to FIG. 4. FIGS. 4A, 4B, and 4C each illustrate the pixel values at the same pixel position Q in the input image of each frame, where the horizontal axis represents time (frames) and the vertical axis represents the pixel values. The change in the pixel values (fluctuation amount) illustrated in FIG. 4B is greater than the change in the pixel values illustrated in FIG. 4A. The change in the pixel values (fluctuation amount) illustrated in FIG. 4C is greater than the change in the pixel values illustrated in FIG. 4B.

Here, the frame corresponding to time t2 is referred to as a current frame, and the frame corresponding to time t1 is referred to as a past frame, which is one or more frames before the current frame. In this case, the obtaining unit 111 calculates the difference between the pixel value at the pixel position Q in the input image of the current frame corresponding to time t2 and the pixel value at the pixel position Q in the input image of the past frame corresponding to time t1. The calculated difference is then obtained as fluctuation information at the pixel position Q in the input image of the current frame corresponding to time t2. There are various methods for calculating the difference between a pixel value and another pixel value (the difference in pixel values between captured images), and the method used here is not limited to a specific one. For example, the obtaining unit 111 may calculate the absolute value of the difference between a pixel value and another pixel value as the difference therebetween. Also, the obtaining unit 111 may calculate the square of the difference between a pixel value and another pixel value as the difference therebetween.

In this way, the obtaining unit 111 obtains fluctuation information for each pixel position in the input image of the current frame. Specifically, the obtaining unit 111 obtains the difference between the pixel value at each of the pixel positions in the input image of the current frame and the pixel value at the corresponding pixel position of the pixel positions in the input image of a past frame prior to the current frame (one or more frames before the current frame). The obtained difference is used as the fluctuation information at the pixel position in the current frame.

In other words, the obtaining unit 111 obtains information regarding the fluctuations in an input image based on the differences between the pixel values of the input image and the corresponding pixel values of at least one image input before or after the input image.

An obtaining unit 112 obtains current focal length information from the imaging optical system 101. The focal length information relates to the focal length, and is, for example, information about the angle of view. For example, the obtaining unit 112 obtains information regarding the current position of a zoom lens of the imaging optical system 101 as the focal length information from an encoder for detecting the position of the zoom lens. If the image processing apparatus has a functional unit that changes the angle of view, such as a teleconverter or a digital zoom processing unit, or can communicate with such a functional unit, the current focal length information may be obtained from the functional unit.

An obtaining unit 113 obtains current subject distance information, from the imaging optical system 101. The subject distance information relates to the distance (subject distance) from the imaging optical system 101 to a subject. For example, the obtaining unit 113 obtains the subject distance information from an encoder included in a lens drive unit of the imaging optical system 101. The encoder detects the position of the focus lens. In the present exemplary embodiment, the subject distance information indicates the position of the focus lens with the focus on a primary subject (hereinafter referred to as a main subject).

The method for obtaining subject distance information is not limited to a specific method. For example, the obtaining unit 113 may use a light detection and ranging (LiDAR) method, through which the subject distance is calculated based on the time it takes for reflected light from a subject to be received by a sensor, or from the phase of the reflected light. Also, if the image processing apparatus includes a light source and a sensor, the Time Of Flight (TOF) method may be used, through which the subject distance is calculated based on the speed of light and the time for light to travel from the light source, reflect off a subject, and return to the sensor. Calculating subject distance information for each region in an input image by any of these methods enables creation of a distance map. In the present exemplary embodiment, the subject distance information about each region is obtained using any of the above methods, but a defocus map indicating the distribution of defocus amounts may be used.

A determination unit 114 determines the intensity of a correction process for correcting fluctuations in an input image. Details of the operation of the determination unit 114 will be described below.

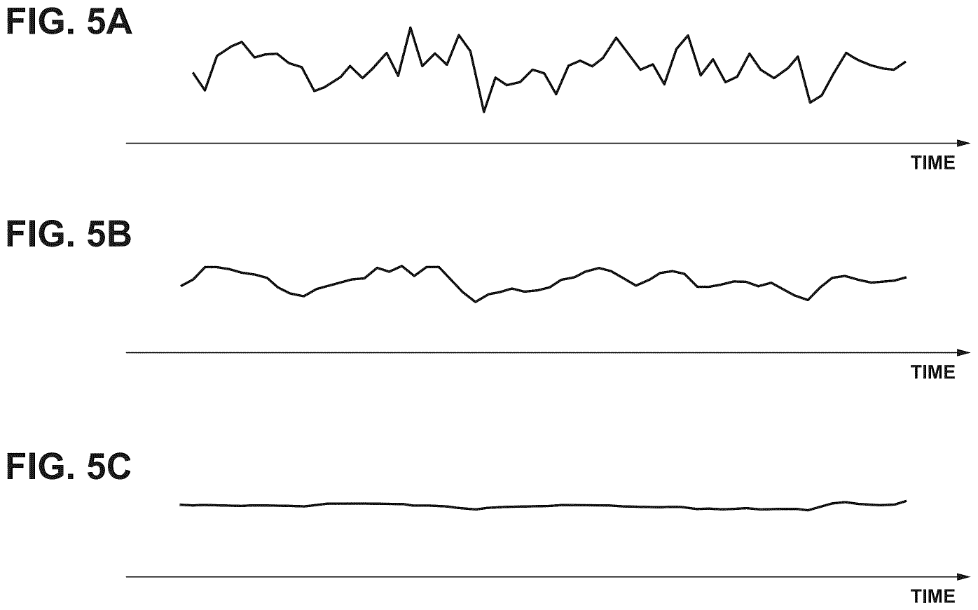

A correction unit 115 applies the correction process with the intensity determined by the determination unit 114 to an input image, and outputs the fluctuation-corrected input image as an output image. The destination for the output image is not limited to a specific location. For example, the correction unit 115 may display the output image on a display unit (not illustrated) of the image processing apparatus, store the output image in a memory (not illustrated) of the image processing apparatus, or transmit the output image to an external apparatus via a network interface (not illustrated) of the image processing apparatus. An example of fluctuation correction to be performed by the correction unit 115 will be described with reference to FIGS. 5A, 5B, and 5C.

FIG. 5A illustrates the pixel values at the same pixel position P in the fluctuation captured images of frames. The horizontal axis represents the frames (time), and the vertical axis represents the pixel values. For fluctuation correction, a smoothing process, such as simple moving average or weighted moving average, is used to smooth input images of a plurality of frames, thus generating an image for the current frame.

FIG. 5B illustrates the change in the pixel values at the pixel position P in the images obtained by applying a smoothing process corresponding to fluctuation correction with a first correction intensity to the input images (fluctuation captured image) in FIG. 5A. FIG. 5C illustrates the change in the pixel values at the pixel position P in the images obtained by applying a smoothing process corresponding to fluctuation correction with a second correction intensity (greater than the first correction intensity) to the input images (fluctuation captured image) in FIG. 5A. The change in pixel values due to fluctuations is approximated by a normal distribution centered at a predetermined position, thus reducing the change in pixel values through the smoothing process in the frame direction.

Also, the number of frames used for the smoothing process may be changed according to the correction intensity. For example, the correction unit 115 increases the number of frames used for the smoothing process as the correction intensity is increased, and decreases the number of frames used as the correction intensity is reduced. The correction unit 115 performs the smoothing process using the input images of the frames corresponding to the number adjusted (changed) in this way to generate the image for the current frame.

Also, the correction unit 115 may change the weighting used for the smoothing process according to the correction intensity. For example, the correction unit 115 increases the weighting value as the correction intensity is increased, and decreases the weighting value as the correction intensity is reduced. The correction unit 115 then performs the smoothing process using the weighting value adjusted (changed) in this way and generates the image for the current frame.

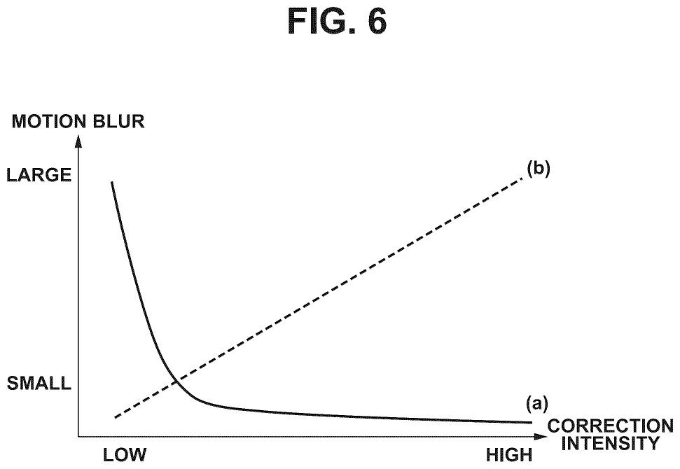

In this way, there is no specific form regarding which parameters in the smoothing process are changed according to the correction intensity. However, increasing the correction intensity of the smoothing process in the frame direction reduces the frame-directional change in pixel values, but motion blur may occur if input images include a moving subject. FIG. 6 illustrates the relationship between correction intensity and fluctuation. A curve (a) represents the frame-directional change in pixel values, and a line (b) represents the degree of motion blur. As illustrated in FIG. 6, increasing the correction intensity can correct a large fluctuation, but this also increases the degree of motion blur, which may lead to decrease in visibility depending on a subject.

A segmentation unit 116 segments an input image into a plurality of regions in accordance with a predetermined number of horizontal and vertical divisions. The functions of the obtaining units 111, 112, and 113, the determination unit 114, and the correction unit 115, as described above, can all be performed on each segmented region, separately. In other words, fluctuation information, focal length information, and subject distance information are obtainable for each segmented region. The correction intensity of the correction process is also determined for each of the plurality of segmented regions, allowing the application of the correction process for correcting fluctuations with different correction intensities, to the input image.

### Description of Operation

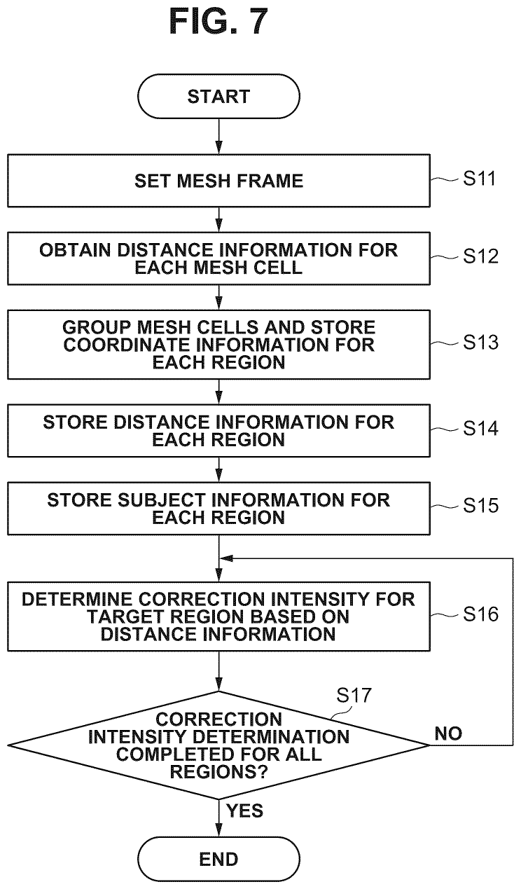

The operation of the determination unit 114 will now be described with reference to the flowchart of FIG. 7. In the fluctuation correction to be performed by the correction unit 115, increasing the correction intensity can reduce a fluctuation amount, but there is an aspect that motion blur increases. In other words, if the correction intensity of the fluctuation correction is increased more than necessary, it may actually lead to a decrease in visibility. In view of this, in order to reduce the fluctuation amount while minimizing motion blur, it is demanded to detect the fluctuation amount with enhanced accuracy and determine the correction intensity.

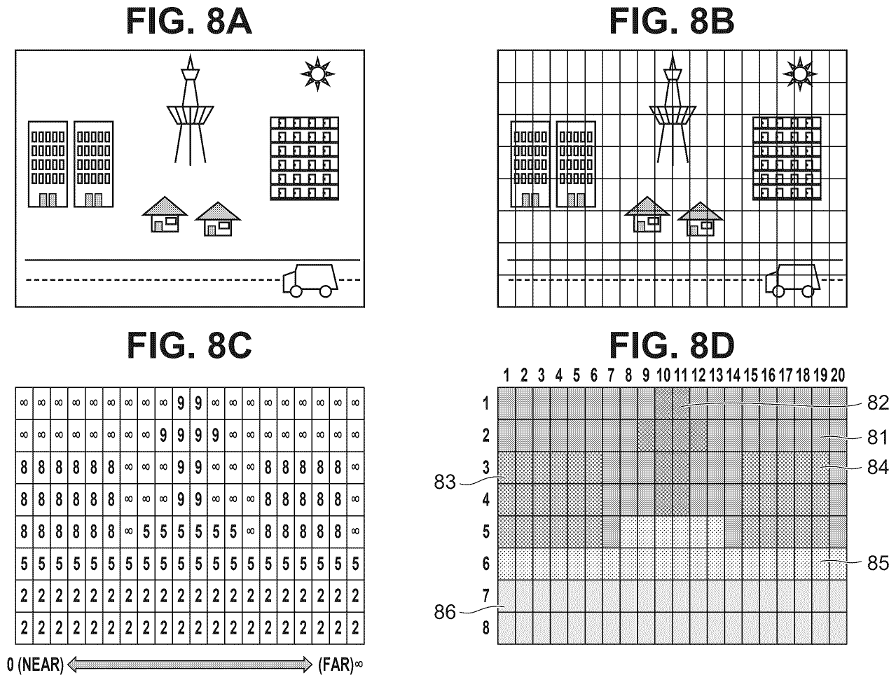

In step S11, the segmentation unit 116 sets a mesh frame of a predetermined size on an input image, thus segmenting the input image into a plurality of regions. For segmentation with a horizontal division number of m and a vertical division number of n, a mesh frame with m×n mesh cells is set. FIG. 8B illustrates an example of setting a mesh frame on the image in FIG. 8A, where a mesh frame with a horizontal division number of 20 and a vertical division number of 8 is set. In a case where the segmentation unit 116 has completed the segmentation of the input image, the processing proceeds to step S12.

In step S12, the obtaining unit 113 obtains subject distance information (distance map), which relates to the subject distance, for each of the plurality of regions (mesh cells) obtained through the segmentation performed by the segmentation unit 116. FIG. 8C illustrates an example of the subject distance information obtained for each mesh cell. The subject distance in each mesh cell is represented by a smaller value for a closer subject and a larger value for a farther subject. In a case where the obtaining unit 113 has completed the obtainment of the subject distance information for each mesh cell, the processing proceeds to step S13.

In step S13, the segmentation unit 116 groups the plurality of mesh cells based on the plurality of pieces of subject distance information to perform region segmentation on the image. The region segmentation can be performed with the mesh cells where the subject distance information is the same among those treated as belonging to the same group. In practice, due to the accuracy of obtaining subject distance information, errors may be included in subject distance information. Thus, a predetermined tolerance range may be set, and the mesh cells where the subject distance information matches among those within this range may be grouped together. In other words, the regions where the subject distance information is substantially the same among them are grouped together. FIG. 8D illustrates a result of region segmentation of an image, achieved by grouping mesh cells in this way. Regions 81 to 86 each represent a segmented region. With the origin set at the top-left corner, the mesh cell at the x-th position horizontally and the y-th position vertically is expressed as (x, y). For example, the region 82 includes 10 mesh cells: (10, 1), (11, 1), (9, 2), (10, 2), (11, 2), (12, 2), (10, 3), (11, 3), (10, 4), and (11, 4). The segmentation unit 116 stores, for each region, the positions of the mesh cells in the corresponding region as coordinate information. In this example, the mesh cells where the subject distance information matches among them are grouped into the same region. However, the conditions for region segmentation may vary. It is sufficient that an image is segmented into at least two regions, for example, a short subject distance region and a long subject distance region, based on whether the subject distance of each mesh cell exceeds a predetermined threshold. In a case where the segmentation unit 116 has completed the region segmentation of the image, the processing proceeds to step S14.

In step S14, the segmentation unit 116 adds distance information to each region. The distance information about each region represents the distance to a subject within the corresponding region (from near to far). The distance information is calculated based on the subject distance information obtained for each mesh cell, using any of the average, maximum, minimum, median, or variance of the values indicated by the plurality of pieces of subject distance information. The segmentation unit 116 stores the calculated distance information for each region. The processing then proceeds to step S15.

In step S15, the segmentation unit 116 adds subject information to each region. The subject information about each region indicates whether a subject within the corresponding region is the main subject, and this is determined based on subject detection information, focus determination information, contrast information, user setting information, and other factors. For example, in a determination method based on subject detection information, a detection target is set in advance, and the presence or absence of a detected subject in each region is stored as subject information. If a construction is set to the detection target in FIG. 8D, a subject(s) is/are detected in the respective regions 82, 83, 84, and 85 among the regions 81 to 86, while no subject is detected in the other regions. Even in a case where information other than subject detection results is used, the subject information can be determined based on information about regions that are in focus, regions with low contrast, such as the sky, regions where the autofocus frame is set by the user, and the like. The segmentation unit 116 stores the determined subject information for each region. The processing then proceeds to step S16.

In step S16, the determination unit 114 determines the correction intensity for a target region based on the distance information about the target region. A method for determining a correction intensity based on distance information will be described. Initially, the factors that cause fluctuation variations will be described. One of the factors affecting fluctuations is the change in the atmospheric refractive index, which is affected by factors such as the wavelength of light, temperature, air pressure, humidity, and carbon dioxide concentration. In consideration of these factors, there is a tendency for fluctuations to increase as the distance to a subject increases. Thus, the correction intensity for the target region is determined so that the correction intensity for the target region is low in a case where the distance information about the target region indicates “near”, and the correction intensity is high in a case where it indicates “far”. The correction intensity determined in this way allows for an appropriate adjustment based on the degree of fluctuation.

More specifically, in each group formed by grouping, or in each region defined through segmentation, the correction intensity for the corresponding group or region determined by the determination unit 114 increases as the distance between the imaging unit and a subject relating thereto increases. In other words, the correction intensity determined by the determination unit 114 reduces as the distance between the imaging unit and the subject decreases. In yet other words, in at least two regions where the subject distance information is different therebetween, among the plurality of segmented regions, the determined correction intensities are different. Conversely, in at least two regions where the subject distance information matches among them, the determined correction intensities are the same. This is a characterizing feature of the image processing apparatus according to the present embodiment.

A method for determining a correction intensity in view of the background will now be described. In the above description, there is a tendency for the degree of fluctuation to increase as the distance to a subject increases. However, some subjects are less affected by fluctuation. For example, flat regions, such as the sky, (hereinafter such regions are referred to as the background) are less affected by fluctuations. This is because the background has inherently small pixel value differences, making it less susceptible to the change in pixel values caused by fluctuations. Thus, the correction intensity for a target region is determined to be low in a case where the target region is identified as the background. A method for identifying background regions involves determining that a target region is the background if the target region does not include the main subject, based on the stored subject information about the target region. Also, a method may be used in which a target region is identified as the background if the distance information about the target region indicates “infinity” (i.e., the distance between the imaging unit and the subject is greater than or equal to a predetermined distance). These functions are executed by an identification unit (not illustrated), and are realized by the CPU 103 executing program(s). The correction intensity for the region or the respective regions identified as the background by the identification unit is set lower than the correction intensities for the regions other than the region(s) identified as the background or is fixed to a predetermined value (e.g., a small value such as zero).

Determining the correction intensities as described above prevents the determination of an unnecessarily high correction intensity for a target region identified as the background. This enables the reduction in motion blur appearing in an image in a case where a moving subject passes through the background. The determination unit 114 stores the coordinate information about the target region and the correction intensity determined therefor in association with each other. The processing then proceeds to step S17.

In step S17, the determination unit 114 determines whether the correction intensity determination has been completed for all the regions defined by the segmentation performed by the segmentation unit 116. If the determination unit 114 determines that the correction intensity determination has been completed (YES in step S17), the determination unit 114 outputs the plurality of pieces of stored coordinate information about all the regions along with the corresponding correction intensities to the correction unit 115. The processing is then ended. If the determination unit 114 determines that the correction intensity determination has not been completed (No in step S17), the processing returns to step S16, and the operation is repeated until the correction intensity determination is completed for all the regions.

Thus, the use of the correction intensity determination process according to the present exemplary embodiment enables appropriate correction intensity determination for each segmented region. This allows for the reduction of the degree of fluctuation in the regions with fluctuation through application of fluctuation correction, while reducing motion blur in the other regions.

In the present exemplary embodiment, an example is provided in which an input image is segmented into a plurality of regions and the regions are grouped based on subject distance information. However, the grouping process may be omitted. In that case, the correction intensity for each of the plurality of segmented regions may be determined. However, considering the computational cost of the CPU 103, it may be desirable to calculate the correction intensity for each group formed by grouping, as in the present embodiment. Also, a table is stored in which a plurality of pieces of subject distance information obtained is each in association with a corresponding correction intensity of the correction intensities determined for the respective pieces of subject distance information. The correction intensity of the correction process to be applied to the respective segmented regions can then be determined by referring to the stored table. This reduces the computational cost of the CPU 103 as compared with a case where the correction intensities for all the segmented regions are determined.

According to the present exemplary embodiment, fluctuations can be corrected with appropriate correction intensities, irrespective of the subject to be captured or the degree of fluctuation.

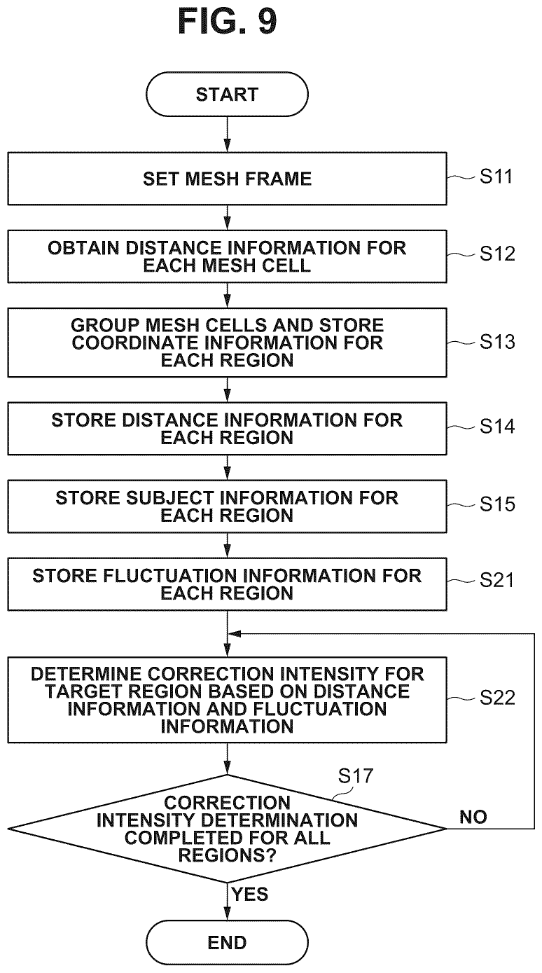

A second exemplary embodiment of the present disclosure will be described. A method by which the determination unit 114 in the present exemplary embodiment determines the correction intensity will be described with reference to the flowchart in FIG. 9. The same operations as those in the first exemplary embodiment are denoted by the same reference numerals, and redundant descriptions thereof will be omitted.

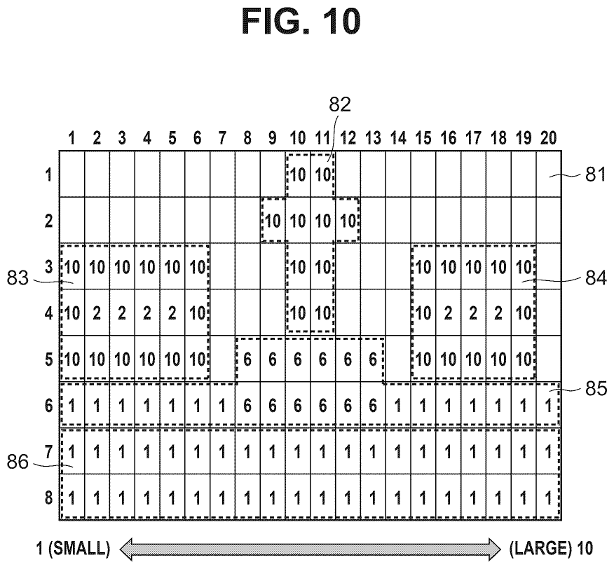

In step S21, the segmentation unit 116 adds information about a fluctuation to each region. The information about the fluctuation in each region is determined based on a plurality of pieces of fluctuation information, obtained by the obtaining unit 111, within the mesh cells of the corresponding region. FIG. 10 illustrates information about a fluctuation in each mesh cell, where a larger value indicates a greater degree of fluctuation. The information about the fluctuation in each region is calculated based on the average, maximum, minimum, median, or variance of the fluctuation amounts indicated by the plurality of pieces of fluctuation information about mesh cells within the corresponding region. It is not necessary to use all the mesh cells in a region. Some embodiments use only the mesh cells at the edge regions or only the mesh cells with high contrast. For example, if only the mesh cells at the edge regions are used for the region 84, the fluctuation information (fluctuation amount) is calculated as 10, using only the mesh cells (15, 3), (16, 3), (17, 3), (18, 3), (19, 3), (15, 4), (19, 4), (15, 5), (16, 5), (17, 5), (18, 5), and (19, 5). Furthermore, as in the region 81, where the distance information about each region stored in step S14 indicates infinity, or where the subject information about each region stored in step S15 indicates the absence of the main subject, the addition of fluctuation information about the corresponding region may be omitted.

The segmentation unit 116 stores the calculated fluctuation information for each region, and the processing proceeds to step S22.

In step S22, the determination unit 114 determines the correction intensity for a target region based on the distance information and the fluctuation information about the target region. Initially, a method for determining a correction intensity based on fluctuation information will be described. The correction intensity for the target region is determined using the fluctuation information stored for the target region. If the fluctuation information about the target region indicates “small”, the correction intensity is determined to be low, whereas if it indicates “large”, the correction intensity is determined to be high. Determining a correction intensity in this manner leads to obtainment of an appropriate correction intensity according to the degree of fluctuation. However, if the change in pixel values that is not caused by fluctuation is present in an image, there is a possibility of an incorrect determination. To address this, a description will be provided of a method for determining a correction intensity based on both distance information and fluctuation information. The correction intensity for the target region is determined based on the value obtained by adding or multiplying the correction intensity determined for the target region based on the fluctuation information described above and the correction intensity determined for the target region in step S16.

Determining a correction intensity in the above-described manner leads to obtainment of an appropriate correction intensity with enhanced accuracy according to the degree of fluctuation. The determination unit 114 stores the coordinate information about the target region and the determined correction intensity in association with each other. The processing then proceeds to step S17.

Thus, according to the correction intensity determination process in the present exemplary embodiment, using fluctuation information additionally in determining a correction intensity as compared with the first exemplary embodiment enables the determination of an appropriate correction intensity with enhanced accuracy.

Thus, fluctuations in the regions with fluctuations can be reduced through fluctuation correction, while motion blur in the other regions can also be minimized.

According to the present exemplary embodiment, fluctuations can be corrected with appropriate correction intensities irrespective of the subject to be captured or the degree of fluctuation.

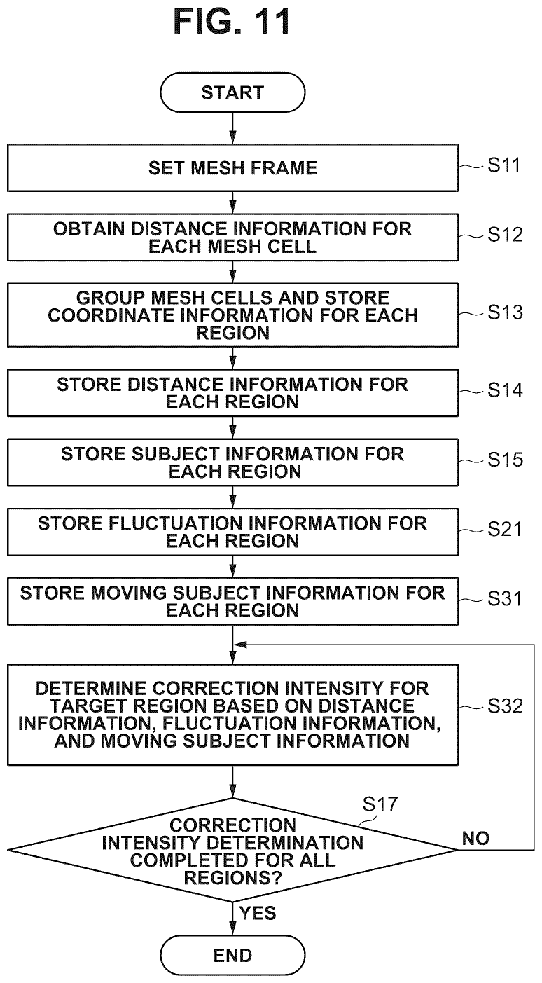

A third exemplary embodiment of the present disclosure will be described. A method by which the determination unit 114 determines a correction intensity will be described with reference to the flowchart in FIG. 11. The same reference numerals are assigned to the same operations as those in the first and second exemplary embodiments, and redundant descriptions are omitted.

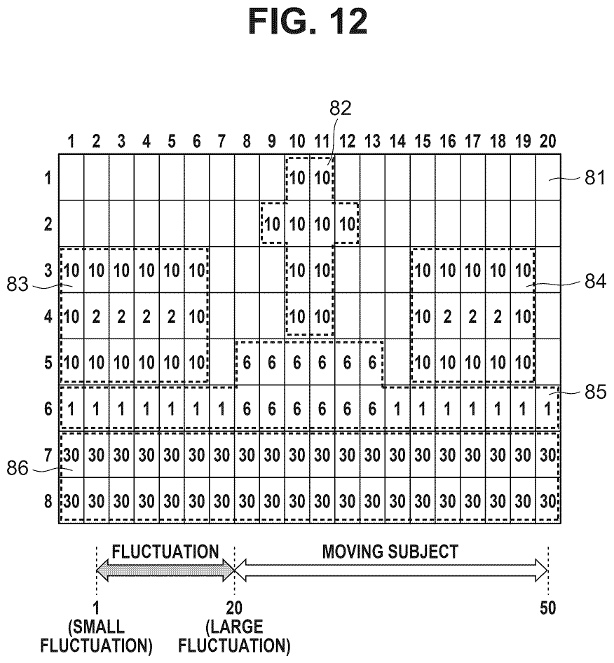

In step S31, the segmentation unit 116 adds motion information to each region. The motion information is determined for each region based on a motion detection result and indicates whether a moving subject is present within the corresponding region. Methods for moving subject detection include optical flow and background subtraction, as well as a method that uses the obtaining unit 111 to detect a moving subject based on the temporal change in pixel values at predetermined coordinates within the image. FIG. 12 represents fluctuation information about each mesh cell, as in FIG. 10. While FIG. 10 illustrates fluctuation information with the absence of a moving subject, FIG. 12 illustrates fluctuation information with the presence of a moving subject in the region 86. If a moving car is present in the region 86, the temporal change in the pixel values at predetermined coordinates will be greater than the pixel value change caused by a fluctuation. This is because a moving subject shifts a greater distance per a predetermined period than the distance that fluctuation shifts. Thus, by setting a predetermined threshold for the temporal change in pixel values, the change in pixel values smaller than the threshold is presumably caused by fluctuation, while the change in pixel values equal to or greater than the threshold is presumably caused by a moving subject. Thus, the presence or absence of a moving subject within a region can be determined. Furthermore, if the difference between minimum and maximum fluctuation amounts within each mesh cell over a predetermined period is large, the pixel value change can also be considered as being caused by a moving subject rather than by a fluctuation. This is because, in the case of a moving subject, frequent entry and exit within a region occur, leading to significant variations in pixel values depending on the presence or absence of the moving subject within the region. Thus, the presence or absence of a moving subject within a region may also be determined based on whether mesh cells where the difference between minimum and maximum fluctuation amounts exceeds a predetermined threshold over a predetermined period are present. The segmentation unit 16 stores the moving subject information determined for each region. The processing then proceeds to step S32.

In step S32, the determination unit 114 determines the correction intensity for a target region based on the distance information and fluctuation information about the target region. In step S16, a method for determining a correction intensity based on the fluctuation information has been described. However, in a case where a moving subject is present in a target region, the fluctuation information about the target region indicates “large” for pixel value changes caused by the moving subject. As a result, according to the above determination method, the correction intensity is determined to be high, leading to motion blur, which is a side effect of fluctuation correction. Thus, the correction intensity for the target region is determined using the moving subject information stored for the target region, so that if the moving subject information about the target region indicates “the presence of a moving subject”, the correction intensity decreases. If the moving subject information indicates “the absence of a moving subject,” the correction intensity for the target region is determined based on the distance information and the fluctuation information about the target region (step S22). The correction intensity for the target region is determined in view of the presence or absence of a moving subject in this manner, so that the correction intensity for the target region is appropriately set while motion blur is reduced. The determination unit 114 stores the coordinate information about the target region and the correction intensity determined for the target region in association with each other. The processing then proceeds to step S17.

Thus, according to the correction intensity determination process in the present exemplary embodiment, additionally using moving subject information in determining a correction intensity as compared with the second exemplary embodiment enables determining an appropriate correction intensity for each segmented region. This reduces fluctuations in the regions with fluctuation through fluctuation correction, while reducing motion blur in the other regions.

According to the present exemplary embodiment, fluctuations can be corrected with an appropriate correction intensity irrespective of the subject to be captured or the degree of the fluctuation.

### Other Exemplary Embodiments

The present disclosure can be implemented by a process in which a program for realizing one or more functions of the above-described first embodiment is read and executed. This program is supplied to a system or apparatus via a network or a computer-readable non-volatile storage medium and is read and executed by one or more processors in the computer of the system or the apparatus.

The present disclosure can also be realized by a circuit (e.g., an application specific integrated circuit (ASIC)) that realizes one or more functions.

### Other Embodiments

Embodiment(s) of the present disclosure can also be realized by a computer of a system or apparatus that reads out and executes computer-executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc™ (BD)), a flash memory device, a memory card, and the like.

While the present disclosure has described exemplary embodiments, it is to be understood that some embodiments are not limited to the disclosed exemplary embodiments. The scope of the following claims is to be accorded the broadest interpretation so as to encompass all such modifications and equivalent structures and functions.

This application claims priority to Japanese Patent Application No. 2024-075196,which was filed on May 7, 2024 and which is hereby incorporated by reference herein in its entirety.

What is claimed is:

1. An image processing apparatus, comprising:
at least one memory storing instructions; and
at least one processor, wherein execution of the stored instructions causes the at least one processor and the at least one memory to:
segment an input image into a plurality of regions;
obtain subject distance information about a subject distance for each of the plurality of regions;
perform a correction process for correcting fluctuation in the input image caused by atmospheric refraction of light, on each of the plurality of regions; and
determine a correction intensity of the correction process for each of the plurality of regions based on the subject distance information about a corresponding region of the plurality of regions,
wherein the determined correction intensities are different in at least two regions where the subject distance information differs between the at least two regions, among the plurality of regions.

2. The image processing apparatus according to claim 1, wherein execution of the stored instructions further causes the at least one processor and the at least one memory to group the plurality of regions based on the subject distance information about each region.

3. The image processing apparatus according to claim 2, wherein the subject distance information about each region indicates a distance between an imaging unit and a subject.

4. The image processing apparatus according to claim 3, wherein, in each of the plurality of regions, the determined correction intensity is higher for a greater distance between the imaging unit and the subject.

5. The image processing apparatus according to claim 3, wherein, in each of the plurality of regions, the determined correction intensity is lower for a shorter distance between the imaging unit and the subject.

6. The image processing apparatus according to claim 3, wherein the correction intensity is determined for each of the groups formed by grouping based on the subject distance information corresponding to a corresponding group of the groups formed by the grouping.

7. The image processing apparatus according to claim 2, wherein the subject distance information about each region indicates a defocus amount in the input image.

8. The image processing apparatus according to claim 2, wherein, among the plurality of regions, regions where the subject distance information is substantially the same among the regions, are grouped into one group.

9. The image processing apparatus according to claim 1,
wherein execution of the stored instructions further causes the at least one processor and the at least one memory to identify a region corresponding to a background of the input image among the plurality of regions, and
wherein the correction intensity for each of the plurality of regions is determined so that a correction intensity of the region identified as the background is lower than correction intensities of the regions other than the region identified as the background.

10. The image processing apparatus according to claim 9, wherein the region corresponding to the background is identified based on the subject distance information about each of the plurality of regions.

11. The image processing apparatus according to claim 9,
wherein whether a distance between an imaging unit and a subject is greater than a predetermined distance is determined for each of the plurality of regions based on the subject distance information about a corresponding region of the plurality of regions, and
wherein a region for which it is determined that the distance between the imaging unit and the subject is greater than the predetermined distance is identified as the region corresponding to the background.

12. The image processing apparatus according to claim 1,
wherein information about the fluctuation in the input image is obtained based on a difference between the input image and at least one image input before or after the input image, and
wherein the correction intensity is determined for each of the plurality of regions based on the information about the fluctuation.

13. The image processing apparatus according to claim 1, wherein, among the plurality of regions, in at least two regions where the subject distance information is the same among the at least two regions, the correction intensities determined for the at least two regions are the same.

14. A image processing method comprising:
segmenting an input image into a plurality of regions;
obtaining subject distance information about a subject distance for each of the plurality of regions;
performing a correction process for correcting fluctuation in the input image caused by atmospheric refraction of light, on each of the plurality of regions; and
determining a correction intensity of the correction process for each of the plurality of regions based on the subject distance information about a corresponding region of the plurality of regions,
wherein the determined correction intensities are different in at least two regions where the subject distance information differs between the at least two regions, among the plurality of regions.

15. A non-transitory computer-readable medium storing computer-executable instructions for causing a computer to execute a method, the method comprising:
segmenting an input image into a plurality of regions;
obtaining subject distance information about a subject distance for each of the plurality of regions;
performing a correction process for correcting fluctuation in the input image caused by atmospheric refraction of light, on each of the plurality of regions; and
determining a correction intensity of the correction process for each of the plurality of regions based on the subject distance information about a corresponding region of the plurality of regions,
wherein the determined correction intensities are different in at least two regions where the subject distance information differs between the at least two regions, among the plurality of regions.
